(19) United States
(12) Patent Application Publication
(10) Pub. No.: US 2023/0367477 A1
(43) Pub. Date: Nov. 16, 2023

(54) STORAGE SYSTEM, DATA MANAGEMENT PROGRAM, AND DATA MANAGEMENT METHOD

(71) Applicant: Hitachi, Ltd., Tokyo (JP)

(72) Inventors: Yuto KAMO, Tokyo (JP); Mitsuo HAYASAKA, Tokyo (JP)

(73) Assignee: Hitachi, Ltd., Tokyo (JP)

(21) Appl. No.: 17/943,705

(22) Filed: Sep. 13, 2022

(30) Foreign Application Priority Data
May 12, 2022 (JP) 2022-079079

(51) Int. Cl. G06F 3/06

(52) U.S. Cl. CPC G06F 3/0608; G06F 3/0659; G06F 3/0673

(57) ABSTRACT

Provided is a storage system to improve a compression effect of data compression. A NAS that, when data of a chunk included in a content matches with data of a chunk of another content, collects data of the chunks as a duplicate chunk storage content, performs compression processing on the duplicate chunk storage content, and stores the compressed duplicate chunk storage content in a storage device. A processor of a NAS head specifies, when data of a chunk included in a predetermined content matches with data of a chunk of another content, a duplicate chunk storage content, in which a chunk similar to the chunks is stored, based on feature information on the chunks, and writes the chunks to the specified duplicate chunk storage content.

### BACKGROUND OF THE INVENTION

### 1. Field of the Invention

The present invention relates to a technique of managing data in a storage system.

### 2. Description of the Related Art

As a storage system for storing a large amount of data used in data analysis or the like, for example, demand for a distributed file storage is increasing. For the distributed file storage, a reduction in bit cost due to a reduction in data capacity to be used is required.

In such a distributed file storage, data reduction such as deduplication and data compression are studied.

As a technique related to the data reduction, for example, a technique is known in which data stored in a cache region in a block storage and input to a drive is grouped based on similarity between data, the data is compressed in units of groups, and the compressed data is stored in the drive (for example, see JP-A-2021-99611 (Patent Literature 1)).

In a storage system, further data reduction is required, and improvement in a compression effect on data compression is required.

### SUMMARY OF THE INVENTION

The invention is made in view of the above circumstances, and an object thereof is to provide a technique capable of improving a compression effect on data compression in a storage system.

In order to achieve the above object, a storage system according to one aspect is a storage system that, when data of a chunk included in a content matches with data of a chunk of another content, collects data of the chunks as a duplicate chunk storage content, performs compression processing on the duplicate chunk storage content, and stores the compressed duplicate chunk storage content in a storage device. A processor of the storage system specifies, when data of a chunk included in a predetermined content matches with data of a chunk of another content, a duplicate chunk storage content, in which a chunk similar to the chunks is stored, based on feature information on the chunks, and write the chunks to the specified duplicate chunk storage content.

According to the invention, it is possible to improve a compression effect on data compression in a storage system.

### BRIEF DESCRIPTION OF THE DRAWINGS

FIG. 1 is a diagram showing an outline of data management of a storage system according to a first embodiment;

FIG. 2 is an overall configuration diagram of a computer system according to the first embodiment;

FIG. 3 is a diagram showing a configuration for storing data according to the first embodiment;

FIG. 4 is a diagram showing a method for extracting a feature value by cutting a chunk from a content according to the first embodiment;

FIG. 5 is a configuration diagram of a duplication state management table according to the first embodiment;

FIG. 6 is a configuration diagram of a duplicate chunk management table according to the first embodiment;

FIG. 7 is a configuration diagram of a duplicate chunk determination table according to the first embodiment;

FIG. 8 is a configuration diagram of a feature management table according to the first embodiment;

FIG. 9 is a flowchart of content data reduction processing according to the first embodiment;

FIG. 10 is a flowchart of chunk deduplication processing according to the first embodiment;

FIG. 11 is a flowchart of chunk read processing according to the first embodiment;

FIG. 12 is a flowchart of chunk update processing according to the first embodiment;

FIG. 13 is a flowchart of chunk deduplication processing according to a second embodiment;

FIG. 14 is a diagram showing a configuration for storing data according to a third embodiment;

FIG. 15 is a configuration diagram of a duplicate chunk management table according to the third embodiment;

FIG. 16 is a configuration diagram of a feature management table according to the third embodiment;

FIG. 17 is a flowchart of chunk deduplication processing according to the third embodiment;

FIG. 18 is a flowchart of similar chunk content movement processing according to the third embodiment;

FIG. 19 is a diagram showing a configuration for storing data according to a fourth embodiment;

FIG. 20 is a configuration diagram of a duplication state management table according to the fourth embodiment;

FIG. 21 is a flowchart of chunk deduplication processing according to the fourth embodiment;

FIG. 22 is a flowchart of chunk read processing according to the fourth embodiment;

FIG. 23 is a flowchart of chunk update processing according to the fourth embodiment;

FIG. 24 is an overall configuration diagram of a computer system according to a fifth embodiment;

FIG. 25 is a configuration diagram of an address conversion table according to the fifth embodiment;

FIG. 26 is a flowchart of content data reduction processing according to the fifth embodiment;

FIG. 27 is a flowchart of block data compression processing according to the fifth embodiment;

FIG. 28 is a diagram showing an outline of processing of grouping and compressing similar chunks according to a sixth embodiment;

FIG. 29 is a configuration diagram of an address conversion table according to the sixth embodiment;

FIG. 30 is a configuration diagram of a feature management table according to the sixth embodiment;

FIG. 31 is a configuration diagram of a special write command according to the sixth embodiment;

FIG. 32 is a flowchart of chunk deduplication processing according to the sixth embodiment; and

FIG. 33 is a flowchart of block update processing according to the sixth embodiment.

### DESCRIPTION OF THE PREFERRED EMBODIMENTS

Embodiments will be described with reference to the drawings. The embodiments described below do not limit the inventions according to the claims, and all elements and combinations thereof described in the embodiments are not necessarily essential to the solution of the invention.

In the following description, processing may be described using a “program” as a subject of an operation. A program may be executed by a processor (for example, a central processing unit (CPU)) to perform predetermined processing while appropriately using a storage resource (for example, a memory) and/or a communication interface device (for example, a network interface card (NIC)), and thus the subject of the processing may be the processor. The processing described by using the program as the subject of the operation may be processing performed by a computer or a system including a processor.

In the following description, information may be described by an expression of an “AAA table”, whereas the information may be expressed by any data structure. That is, in order to indicate that the information does not depend on the data structure, the “AAA table” can be referred to as “AAA information”.

In the following description, files and objects, which are management units for managing data, may be collectively referred to as a content.

First, an outline of data management in a storage system of a computer system according to a first embodiment will be described.

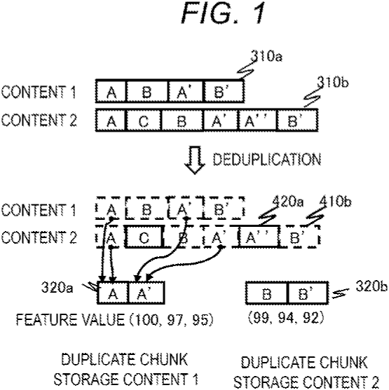

FIG. 1 is a diagram showing the outline of the data management of the storage system according to the first embodiment.

In the storage system, deduplication is performed on a plurality of contents to be managed in units of predetermined chunks. In the deduplication, the storage system stores a duplicate chunk in a duplicate chunk storage content. Further, the storage system stores similar duplicate chunks in the same duplicate chunk storage content based on information indicating features of each chunk (feature information: feature value).

FIG. 1 shows an example in which the storage system stores a content 310a (content 1) having chunks of contents A, B, A′, and B′ and a content 310b (content 2) having chunks of contents A, C, B, A′, A″, and B′. Here, A, A′, and A″ indicate that the contents are similar and the feature values are the same. B and B′ indicate that the contents are similar and the feature values are the same. In the example of FIG. 1, the feature value is a set of a predetermined number (for example, three) of hash values from a maximum value of a plurality of hash values obtained by rolling hash for each chunk.

In this example, since A, A′, B, and B′ are duplicated in the content 1 and the content 2, the chunks storing these contents are determined to be duplicate chunks 410, and each of the contents is deleted from the content 1 and the content 2 and stored in duplicate chunk storage contents 320. In the present embodiment, since the chunks storing A and A′ are similar chunks and the chunks storing B and B′ are similar chunks, the chunks storing A and A′ are grouped into a same duplicate chunk storage content 320a, and the chunks storing B and B′ are stored and managed in a same duplicate chunk storage content 320b. Here, although each of the duplicate chunk storage contents is compressed and stored in a storage device, compression efficiency by compression processing can be improved because the similar chunks are stored in the same duplicate chunk storage content.

Next, a computer system according to the first embodiment will be described.

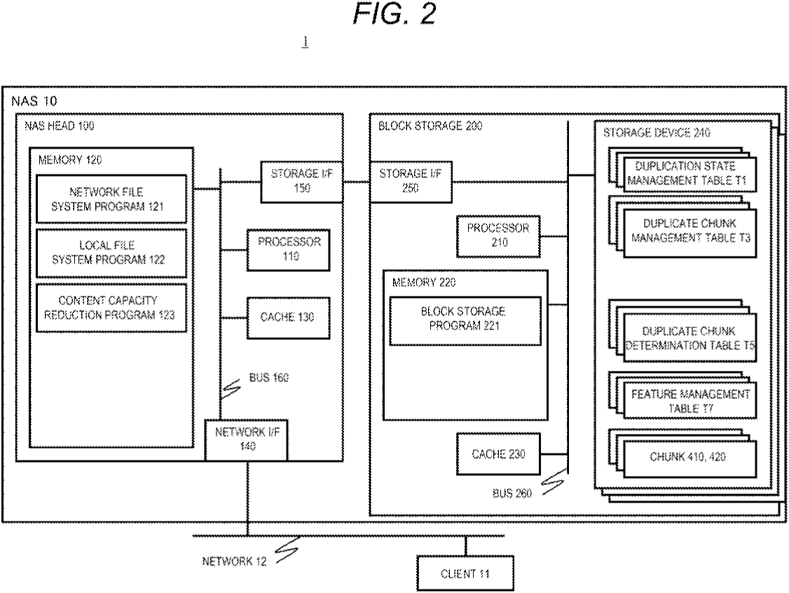

FIG. 2 is an overall configuration diagram of the computer system according to the first embodiment.

A computer system 1 includes a network attached storage (NAS) 10, which is an example of the storage system, and a client 11. The NAS 10 and the client 11 are connected to each other via a network 12. The network 12 is, for example, a local area network (LAN) or a wide area network (WAN).

The NAS 10 includes a NAS head 100, which is an example of a file storage, and a block storage 200. Instead of the single NAS 10, a distributed file storage formed of a plurality of NASs may be used. A storage system including an object storage and a block storage may be used instead of the NAS 10. The NAS head 100 and the block storage 200 may be integrated by a single computer.

The NAS head 100 is a file storage that manages data as a file (content), and includes a processor 110, a memory 120, a cache 130, a network I/F (interface) 140, a storage I/F 150, and a bus 160. The processor 110, the memory 120, the cache 130, the network I/F 140, and the storage I/F 150 are connected via the bus 160.

The network I/F 140 is, for example, an interface such as a wired LAN card or a wireless LAN card, and communicates with another device (for example, the client 11) via the network 12.

The storage I/F 150 is an interface for communicating with the block storage 200.

The processor 110 executes programs stored in the memory 120 to perform overall operation control of the NAS head 100 and the NAS 10.

The memory 120 is, for example, a random access memory (RAM), and temporarily stores programs and data for executing the operation control by the processor 110. The memory 120 stores a network file system program 121, a local file system program 122, and a content capacity reduction program 123 as examples of a data management program. The programs and information stored in the memory 120 may be stored in a storage device 240, which will be described later, of the block storage 200.

The network file system program 121 is executed by the processor 110 to receive various requests such as Read/Write from the client 11 or the like and process a protocol included in the requests. For example, the network file system program 121 processes a protocol such as native-client, file system in user space (FUSE), network file system (NFS), and server message block (SMB).

The local file system program 122 is executed by the processor 110 to provide a file system or a content storage such as an object storage to the network file system program 121.

The content capacity reduction program 123 is executed by the processor 110 to execute processing (content data reduction processing) of reducing capacity of a content of a user stored in the storage device 240 in an in-line process or in a post process.

The cache 130 is, for example, a RAM, and temporarily stores data written from the client 11 and data read from the block storage 200.

The block storage 200 provides the NAS head 100 with a storage function in a block format such as a fibre channel storage area network (FC-SAN). The block storage 200 includes a processor 210, a memory 220, a cache 230, the storage device 240, and a storage I/F 250.

The processor 210 executes a program stored in the memory 220 to perform operation control of the block storage 200.

The memory 220 is, for example, a RAM, and temporarily stores a program and data for executing the operation control of the processor 210. The memory 220 stores a block storage program 221. The block storage program 221 is executed by the processor 210 to provide the NAS head 100 with a function of the block storage.

The cache 230 temporarily stores data written from the NAS head 100 and data read from the storage device 240. The storage I/F 250 performs communication between the storage device 240 and the NAS head 100.

The storage device 240 is, for example, a hard disk or a flash memory, and stores various contents including contents (files in the example of FIG. 2) used by the user of the client 11. The storage device 240 stores a duplication state management table T1, a duplicate chunk management table T3, a duplicate chunk determination table T5, a feature management table T7, chunks 410 and 420, and the like.

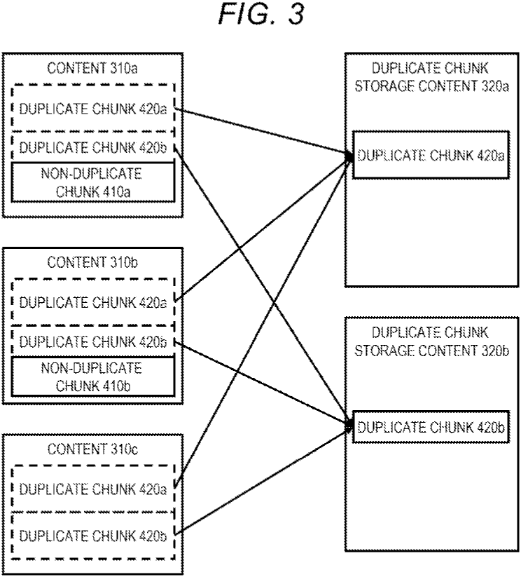

FIG. 3 is a diagram showing a configuration for storing data according to the first embodiment.

FIG. 3 shows an example in which the content 310a, the content 310b, and a content 310c are included as the contents of the user stored in the NAS 10. Here, the content 310a includes a duplicate chunk 420a duplicating a chunk of another content, a duplicate chunk 420b, and a non-duplicate chunk 410a not duplicating a chunk of another content. The content 310b includes the duplicate chunk 420a, the duplicate chunk 420b, and a non-duplicate chunk 410b. The content 310c includes the duplicate chunk 420a and the duplicate chunk 420b.

In this case, when deduplication processing is performed, the duplicate chunks 420a are stored in the duplicate chunk storage content 320a and deleted from the contents 310a, 310b, and 310c. The duplicate chunks 420b are stored in the duplicate chunk storage content 320b and deleted from the contents 310a, 310b, and 310c. In this way, by performing the deduplication processing, a state in which a plurality of duplicate chunks are stored in the NAS 10 is resolved, and necessary data capacity can be reduced.

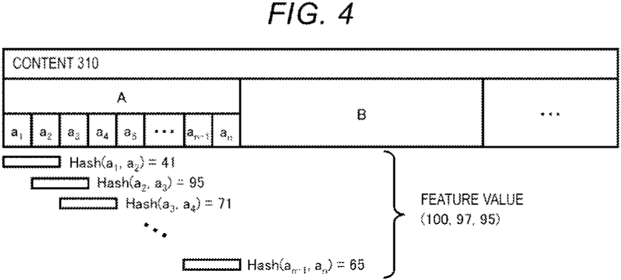

FIG. 4 is a diagram showing a method for extracting a feature value of a chunk by cutting the chunk from the content according to the first embodiment.

In the present embodiment, a target content is divided into chunks having a variable length (variable-length chunks) by rolling hash processing. Here, the rolling hash processing is processing of executing processing (hash calculation) of calculating a hash value for data of a window (partial data unit) having a predetermined length on the target content while shifting the window. As a method for dividing the content into the variable-length chunks, there is a method in which, when the calculated hash value is a predetermined value (65 in the example of FIG. 4), the portion is set as a division point of the variable-length chunks. As specific processing of dividing the content into the variable-length chunks, for example, a Rabin-Karp algorithm can be adopted. The processing of dividing the content into the variable-length chunks is not limited to the above processing, and any processing may be used.

As the division processing of the variable-length chunks, a two threshold two divisor (TTTD) method may be used in which a minimum chunk size and a maximum chunk size are determined in advance, the rolling hash processing is executed from the minimum chunk size, and variable-length chunks are determined within that range. Even in this case, in order to acquire the feature value of the chunk, the hash value may be acquired by performing the rolling hash processing even in the window in the range of the minimum chunk size.

The feature value (feature information) of the chunk may be information based on hash values for a plurality of windows obtained by the rolling hash processing in the chunk when the chunk is divided. For example, the feature value may be a set of a predetermined number (for example, three) from a maximum value of the plurality of hash values calculated in the chunks of the content, a set of a predetermined number from a minimum value, a set of the maximum value, an intermediate value, and the minimum value, or an average value of the plurality of hash values.

Next, the duplication state management table T1 will be described.

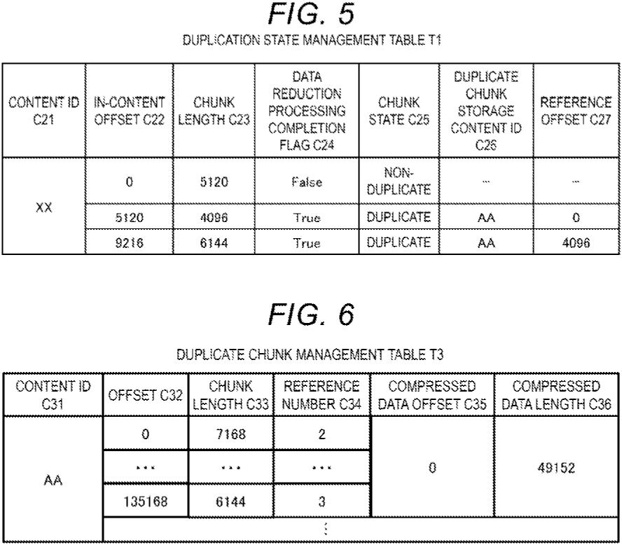

FIG. 5 is a configuration diagram of the duplication state management table according to the first embodiment.

The duplication state management table T1 is provided for each file system of the NAS 10. The duplication state management table T1 includes an entry for each content. The entry in the duplication state management table T1 includes a content ID C21 and field groups (C22 to C27) for each chunk in the content corresponding to the entry.

The content ID C21 stores an ID (content ID) of the content corresponding to the entry.

The field groups in the chunk includes fields of an in-content offset C22, a chunk length C23, a data reduction processing completion flag C24, a chunk state C25, a duplicate chunk storage content ID C26, and a reference offset C27.

The in-content offset C22 stores a start position of the chunk corresponding to the field group in the content. The chunk length C23 stores a data length (chunk length) of the chunk corresponding to the field group. The data reduction processing completion flag C24 stores a data reduction processing completion flag indicating whether the chunk corresponding to the field group is subjected to the content data reduction processing. The data reduction processing completion flag is set to “False” when data in the chunk is updated, and is set to “True” after the content data reduction processing. The chunk state C25 stores a state of the chunk corresponding to the field group. The state of the chunk includes “NON-DUPLICATE”, which indicates that the chunk does not duplicate another chunk, and “DUPLICATE”, which indicates that the chunk duplicates another chunk. For a chunk whose chunk state is “NON-DUPLICATE”, values are not set in the duplicate chunk storage content ID C26 and the reference offset C27. The duplicate chunk storage content ID C26 stores an ID (content ID) of a content (duplicate chunk storage content) that stores data of the chunk (duplicate chunk) that duplicates the chunk corresponding to the field group. The reference offset C27 stores an offset (start position) in the duplicate chunk storage content for storing the data of the chunk that duplicates the chunk corresponding to the field group.

Next, the duplicate chunk management table T3 will be described.

FIG. 6 is a configuration diagram of the duplicate chunk management table according to the first embodiment.

The duplicate chunk management table T3 is a table that is provided for each file system of the NAS 10, used for managing the duplicate chunks stored in the duplicate chunk storage content in the file system, and stores an entry for each duplicate chunk storage content. The entry in the duplicate chunk management table T3 includes fields of a content ID C31, an offset C32 for each chunk of the duplicate chunk storage content, a chunk length C33, a reference number C34, a compressed data offset C35, and a compressed data length C36.

The content ID C31 stores an ID (content ID) of the duplicate chunk storage content corresponding to the entry. The offset C32 stores a start position of each duplicate chunk in the duplicate chunk storage content corresponding to the entry. The chunk length C33 stores a data length of each duplicate chunk. The reference number C34 stores a number (reference number) referred to from the content of each duplicate chunk. The compressed data offset C35 stores a start position of compressed data of the duplicate chunk storage content corresponding to the entry. The compressed data length C36 stores a data length of the compressed data of the duplicate chunk storage content corresponding to the entry.

Next, the duplicate chunk determination table T5 will be described.

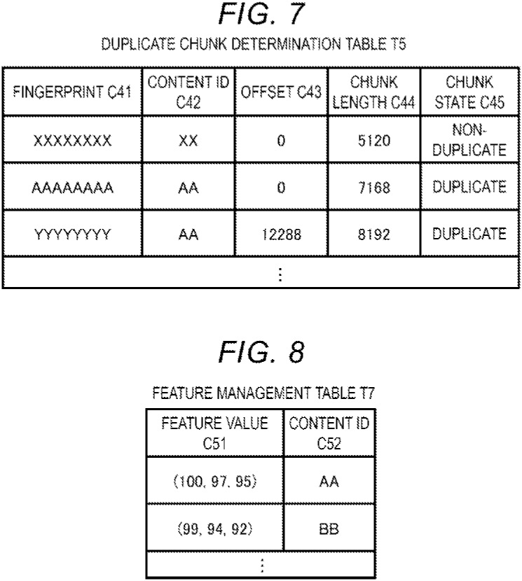

FIG. 7 is a configuration diagram of the duplicate chunk determination table according to the first embodiment.

The duplicate chunk determination table T5 is a table that is provided for each file system of the NAS 10 and stores information used for determining the duplication of the chunks of the content in the file system, and stores an entry for each chunk of the content. The entry in the duplicate chunk determination table T5 includes fields of a fingerprint C41, a content ID C42, an offset C43, a chunk length C44, and a chunk state C45.

The fingerprint C41 stores a fingerprint of the chunk corresponding to the entry. A fingerprint is a value obtained by applying a hash function to the data of the chunk, and is used to confirm identity (duplication) of the chunk. As a method for calculating the fingerprint, for example, message digest algorithm 5 (MD5) or secure hash algorithm 1 (SHA-1) may be used. The content ID C42 stores a content ID of the content storing the chunk corresponding to the entry. The offset C43 stores an offset in the content of the chunk corresponding to the entry. The chunk length C44 stores a data length of the chunk corresponding to the entry. The chunk state C45 stores a state of the chunk corresponding to the entry. The state of the chunk includes “NON-DUPLICATE” and “DUPLICATE”.

Next, the feature management table T7 will be described.

FIG. 8 is a configuration diagram of the feature management table according to the first embodiment.

The feature management table T7 is a table that is provided for each file system of the NAS 10 and manages feature information for each duplicate chunk storage content in the file system, and stores an entry for each duplicate chunk storage content. The entry of the feature management table T7 includes fields of a feature value C51 and a content ID C52.

The feature value C51 stores a feature value of the chunk stored in the duplicate chunk storage content corresponding to the entry. The content ID C52 stores a content ID of the duplicate chunk storage content corresponding to the entry.

In the present embodiment, each entry in the feature management table T7 may be registered in advance by the user. In this case, it is assumed that the duplicate chunk storage content corresponding to the content ID of each entry is prepared in the NAS 10.

In the present embodiment, the duplication state management table T1, the duplicate chunk management table T3, the duplicate chunk determination table T5, and the feature management table T7 are provided for each file system, whereas each of the tables may be provided for a plurality of file systems.

Next, the content data reduction processing in the NAS 10 will be described.

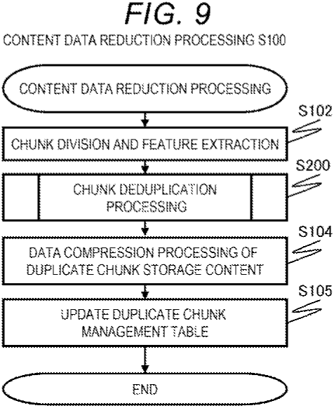

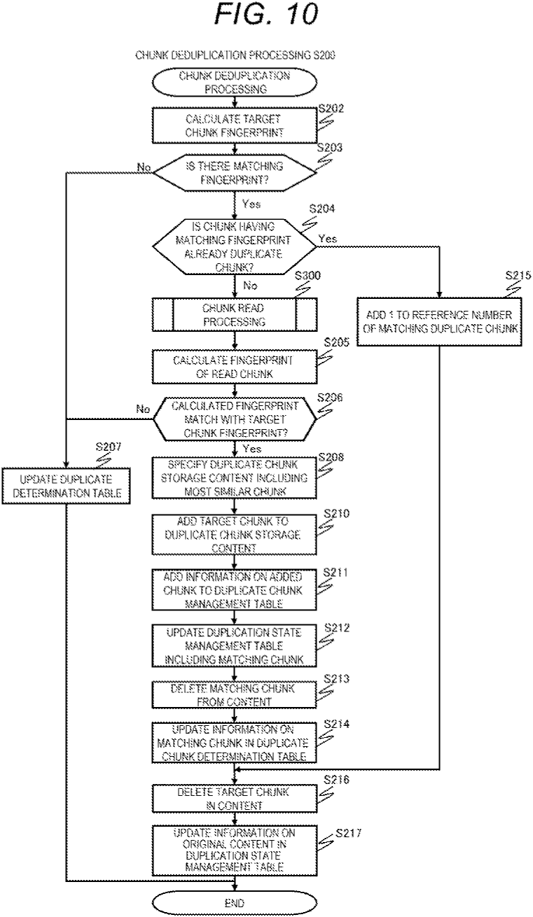

FIG. 9 is a flowchart of the content data reduction processing according to the first embodiment.

The content data reduction processing is executed as processing (post process) after a content corresponding to an I/O request from the client 11 is stored, while may be executed as processing (in-line process) when the content corresponding to the I/O request is stored.

The content capacity reduction program 123 (strictly speaking, the processor 110 that executes the content capacity reduction program 123) performs processing of dividing a content that is not subjected to the content data reduction processing, as a processing target, into chunks having variable lengths (variable-length chunks) by a rolling hash or the like, and extracting feature values of the chunks (S102).

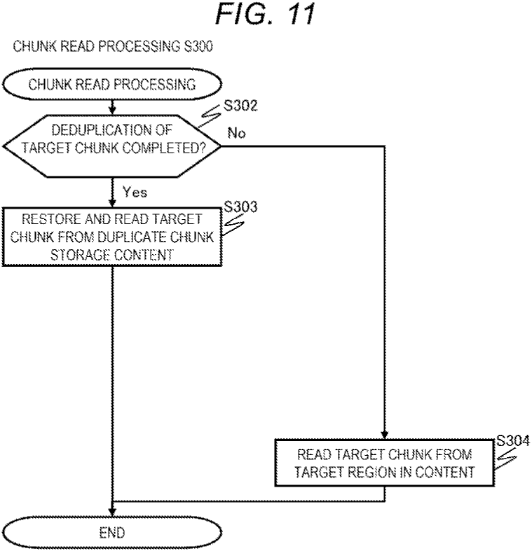

Next, the content capacity reduction program 123 executes chunk deduplication processing (see FIG. 10) of depriving duplicate chunks from the content by storing the duplicate chunks in the duplicate chunk storage content for each chunk obtained by the division (S200).

Next, the content capacity reduction program 123 performs data compression processing of compressing the data of the duplicate chunk storage content obtained by the chunk deduplication processing (S104), updates a content corresponding to a result of the data compression processing in the duplicate chunk management table T3, that is, the compressed data offset and the compressed data length (S105), and ends the processing.

Next, the chunk deduplication processing S200 will be described.

FIG. 10 is a flowchart of the chunk deduplication processing according to the first embodiment.

The content capacity reduction program 123 calculates a fingerprint of a chunk to be processed (target chunk) (S202).

The content capacity reduction program 123 determines whether there is a fingerprint that matches with the calculated fingerprint in the duplicate chunk determination table T5 (S203).

As a result, when it is determined that there is no matching fingerprint (S203: No), it means that the target chunk is not a duplicate chunk. Therefore, the content capacity reduction program 123 updates the duplicate chunk determination table T5 by adding an entry corresponding to the target chunk (S207), and ends the processing.

On the other hand, when it is determined that there is a matching fingerprint (S203: Yes), it means that the target chunk is a duplicate chunk. Therefore, the content capacity reduction program 123 determines whether the chunk having the matching fingerprint (matching chunk) is already managed as a duplicate chunk (S204).

As a result, when the matching chunk is managed as the duplicate chunk (S204: Yes), the content capacity reduction program 123 adds 1 to the reference number of the entry of the matching chunk in the duplicate chunk management table T3 (S215), and causes the processing to proceed to step S216.

On the other hand, when the matching chunk is not managed as the duplicate chunk (S204: No), the content capacity reduction program 123 executes chunk read processing (see FIG. 11) of reading the data of the chunk for the matching chunk (S300).

Next, the content capacity reduction program 123 calculates a latest fingerprint of the read matching chunk (S205), and determines whether the latest fingerprint of the matching chunk matches with the fingerprint of the target chunk (S206).

As a result, when it is determined that the fingerprint of the matching chunk does not match with the fingerprint of the target chunk (S206: No), it means that the matching chunk is updated and does not duplicate the target chunk. Therefore, the content capacity reduction program 123 causes the processing to proceed to step S207.

On the other hand, when it is determined that the fingerprint of the matching chunk matches with the fingerprint of the target chunk (S206: Yes), it means that the matching chunk and the target chunk duplicate each other. Therefore, the content capacity reduction program 123 specifies the duplicate chunk storage content for storing a chunk most similar to (including the case of matching with) the feature of the target chunk (S208). Specifically, the content capacity reduction program 123 refers to the feature management table T7 based on a feature value of the target chunk, and specifies the content ID of the duplicate chunk storage content having the most similar feature value.

Next, the content capacity reduction program 123 adds the target chunk to the specified duplicate chunk storage content (S210).

Next, the content capacity reduction program 123 adds information (offset, chunk length, reference number) on the added chunk to the duplicate chunk management table T3 (S211).

Next, the content capacity reduction program 123 updates the information on the content including the matching chunk in the duplication state management table T1 (S212). Specifically, the content capacity reduction program 123 changes the chunk state C25 of the entry corresponding to the matching chunk in the duplication state management table T1 to “DUPLICATE”, stores the content ID of the duplicate chunk storage content obtained by adding the target chunk to the duplicate chunk storage content ID C26, and stores a start position at which the target chunk of the duplicate chunk storage content is added to the reference offset C27.

Next, the content capacity reduction program 123 deletes the matching chunk from the content including the matching chunk (S213), and updates the information on the matching chunk in the duplicate chunk determination table T5 (S214). Specifically, the content capacity reduction program 123 updates the content ID, the offset, and the chunk length of the entry corresponding to the matching chunk in the duplicate chunk determination table T5 to the information on the target chunk added to the duplicate chunk storage content, and sets the chunk state C45 as duplication.

After executing step S214 or step S215, the content capacity reduction program 123 deletes the target chunk from an original content in which the target chunk is stored (S216). Next, the content capacity reduction program 123 updates the information on the original content in the duplication state management table T1 (S217), and ends the processing. Specifically, the content capacity reduction program 123 sets the chunk state C25 of the entry of the original content in the duplication state management table T1 to “DUPLICATE”, updates the duplicate chunk storage content ID and the reference offset to the information on the target chunk added to the duplicate chunk storage content, and ends the processing.

Next, the chunk read processing S300 will be described.

FIG. 11 is a flowchart of the chunk read processing according to the first embodiment.

The content capacity reduction program 123 determines whether deduplication of a chunk to be processed (target chunk in the description of the processing) is completed (S302). Specifically, the content capacity reduction program 123 refers to the entry of the target chunk in the duplication state management table T1, and determines whether the data deletion processing completion flag of the data reduction processing completion flag C24 is “True” and the chunk state is “DUPLICATE”.

As a result, when the deduplication is completed (S302: Yes), since the duplicate chunk storage content storing the target chunk is compressed and stored in the block storage 200, the content capacity reduction program 123 acquires the compressed target chunk from the block storage 200, restores the compressed target chunk (S303), and ends the processing.

On the other hand, when the deduplication is not completed (S302: No), since the content storing the target chunk is not compressed in the present embodiment, the content capacity reduction program 123 acquires the target chunk from the block storage 200 (S304), and ends the processing. Chunks that are not duplicate chunks may also be compressed and stored in the block storage 200. In this case, the chunks may be acquired from the block storage 200 and restored.

Next, chunk update processing will be described.

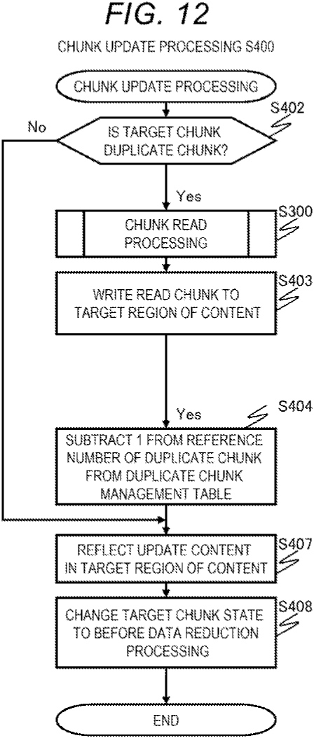

FIG. 12 is a flowchart of the chunk update processing according to the first embodiment.

The chunk update processing is executed as an in-line process, for example, at the time of processing corresponding to a content update request from the client 11.

The content capacity reduction program 123 refers to the duplication state management table T1 and determines whether a chunk to be updated in the content (referred to as a target chunk in the processing) is a duplicate chunk (S402).

As a result, when the target chunk is not a duplicate chunk (S402: No), the content capacity reduction program 123 cause the processing to proceed to step S407.

On the other hand, when the target chunk is a duplicate chunk (S402: Yes), the content capacity reduction program 123 performs the chunk read processing on the target chunk (S300).

Next, the content capacity reduction program 123 writes the read target chunk in a target region of the content (S403), subtracts 1 from the reference number of the duplicate chunk corresponding to the target chunk from the duplicate chunk management table T3 (S404), and causes the processing to proceed to step S407.

In step S407, the content capacity reduction program 123 reflects an update content of the content in the target region of the content.

Next, in the entry of the target chunk in the duplication state management table T1, the data reduction processing completion flag is changed to a value indicating that the data reduction processing is not completed (before the data reduction processing) (S408), and the processing ends.

When an update target is the entire chunk, since it is not necessary to acquire the data of a current chunk, steps S300 and S403 may not be executed. Although the read chunk is written in the target region of the content in step S403, the update content of the chunk may be merged and written in the target region of the content in this step. In this case, the processing of step S407 may be omitted.

Next, a computer system according to a second embodiment will be described. The computer system according to the second embodiment is different from the computer system according to the first embodiment only in a part of chunk deduplication processing. The same parts as those of the computer system according to the first embodiment will be described using the same reference numerals.

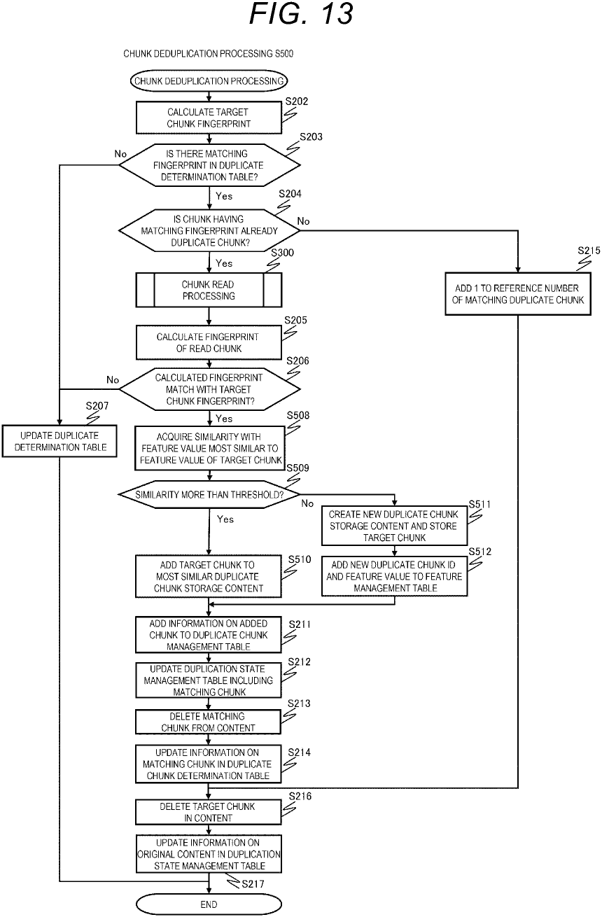

FIG. 13 is a flowchart of chunk deduplication processing according to the second embodiment. In chunk deduplication processing S500 of FIG. 13, the same steps as those in the chunk deduplication processing S200 according to the first embodiment of FIG. 10 are denoted by the same reference numerals, and repeated description thereof may be omitted.

In step S206, when it is determined that the fingerprint of the matching chunk matches with the fingerprint of the target chunk (S206: Yes), it means that the matching chunk and the target chunk duplicate each other. Therefore, the content capacity reduction program 123 acquires similarity with a feature value that is the most similar to (including the case of matching with) the feature value of the target chunk (S508). Specifically, the content capacity reduction program 123 refers to the feature management table T7, and acquires the similarity at which a ratio (similarity) of matching hash values among a predetermined number of hash values representing the feature values is maximum with respect to the feature value of the feature management table T7 and the feature value of the target chunk.

Next, the content capacity reduction program 123 determines whether the acquired similarity is equal to or greater than a threshold (S509).

As a result, when the similarity is equal to or greater than the threshold (S509: Yes), the content capacity reduction program 123 adds the target chunk to the duplicate chunk storage content corresponding to the most similar feature value (S510), and causes the processing to proceed to step S211.

On the other hand, when the similarity is not equal to or greater than the threshold (S509: No), the content capacity reduction program 123 additionally creates a duplicate chunk storage content, stores the target chunk in the duplicate chunk storage content (S511), adds an entry including the content ID of the created duplicate chunk storage content and the feature value of the target chunk to the feature management table T7 (S512), and causes the processing to proceed to step S211.

According to the computer system in the second embodiment, it is not necessary to prepare in advance the duplicate chunk storage content for storing the duplicate chunk corresponding to each feature value and register the duplicate chunk storage content in the feature management table T7, and it is possible to appropriately create the duplicate chunk storage content and set the content thereof in the feature management table T7.

Next, a computer system according to a third embodiment will be described. The computer system according to the third embodiment is a system in which, in the computer system according to the third embodiment, when a group of chunks (similar chunk group) having the similarity equal to or greater than predetermined similarity stored in the duplicate chunk storage content satisfies a predetermined reference (for example, a total amount of data of chunks is equal to or greater than a predetermined amount, or the number of chunks is equal to or greater than a predetermined number), the similar chunk group is written to another duplicate chunk storage content (similar duplicate chunk storage content). In the computer system according to the third embodiment, parts similar to those of the computer system according to the first embodiment will be described using the same reference numerals.

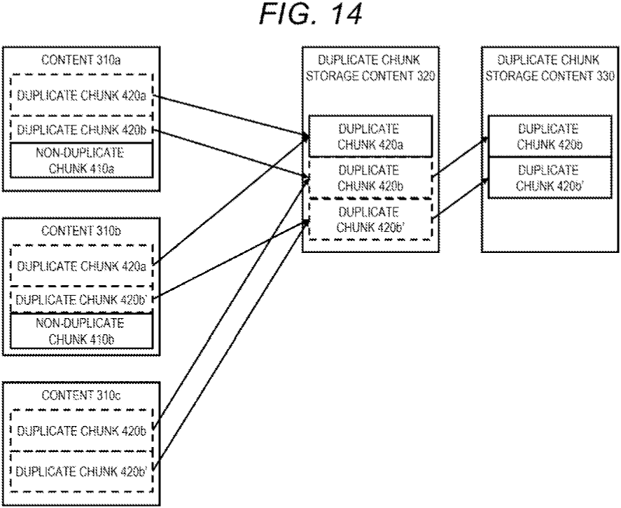

FIG. 14 is a diagram showing a configuration for storing data according to the third embodiment.

FIG. 14 shows an example in which the content 310a, the content 310b, and the content 310c are included as the contents of the user stored in the NAS 10. Here, the content 310a includes the duplicate chunk 420a duplicating a chunk of another content, the duplicate chunk 420b, and the non-duplicate chunk 410a not duplicating a chunk of another content, the content 310b includes the duplicate chunk 420a, a duplicate chunk 420b′, and the non-duplicate chunk 410b, and the content 310c includes the duplicate chunk 420b and the duplicate chunk 420b′. Here, it is assumed that the similarity between feature values of the duplicate chunk 420b and the duplicate chunk 420b′ is equal to or greater than a predetermined value.

In this case, when deduplication processing is performed, the duplicate chunks 420a are stored in the duplicate chunk storage content 320 and deleted from the contents 310a and 310b. The duplicate chunks 420b are stored in the duplicate chunk storage content 320 and deleted from the contents 310a and 310c. The duplicate chunks 420b′ are stored in the duplicate chunk storage content 320 and deleted from the contents 310b and 310c. Here, in the duplicate chunk storage content 320, when the group of stored duplicate chunks (similar chunk group) having the similarity equal to or greater than the predetermined similarity satisfies the predetermined reference, a new similar duplicate chunk storage content 330 is created, and the duplicate chunks 420b and 420b′, which are the similar chunks in the duplicate chunk storage content 320, are written to the similar duplicate chunk storage content 330.

Accordingly, it is possible to collectively write the similar chunk groups satisfying the predetermined reference to another duplicate chunk storage content, and to appropriately collect the similar chunks in the same duplicate chunk storage content, thereby improving compression efficiency.

The storage device 240 of the block storage 200 according to the third embodiment includes a duplicate chunk management table T31 instead of the duplicate chunk management table T3, and includes a feature management table T71 instead of the feature management table T7.

Next, the duplicate chunk management table T31 will be described.

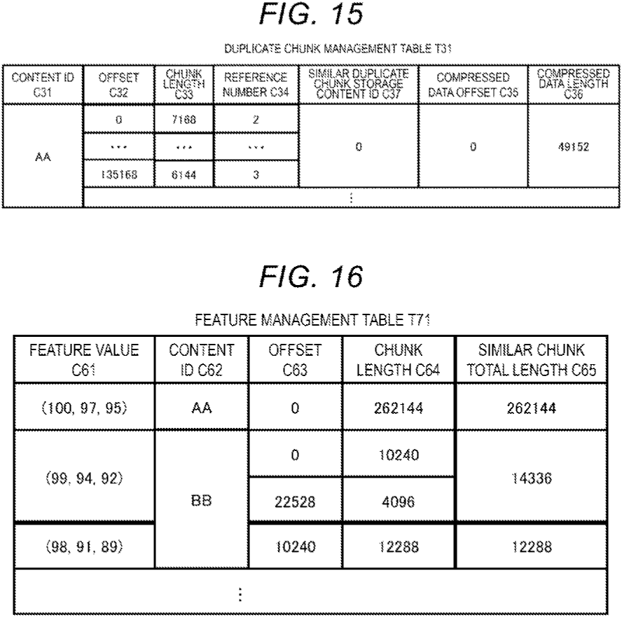

FIG. 15 is a configuration diagram of the duplicate chunk management table according to the third embodiment.

The duplicate chunk management table T31 further includes a field of a similar duplicate chunk storage content ID C37 with respect to the entry in the duplicate chunk management table T3.

The similar duplicate chunk storage content ID C37 stores a content ID of the duplicate chunk storage content (similar duplicate chunk storage content) to which the chunk is written when the chunk stored in the duplicate chunk storage content corresponding to the entry satisfies the reference (a data length is equal to or greater than a predetermined value, or the number of chunks is equal to or greater than a predetermined value). The similar duplicate chunk storage content is also managed as the duplicate chunk storage content in the duplicate chunk management table T31.

Next, the feature management table T71 will be described.

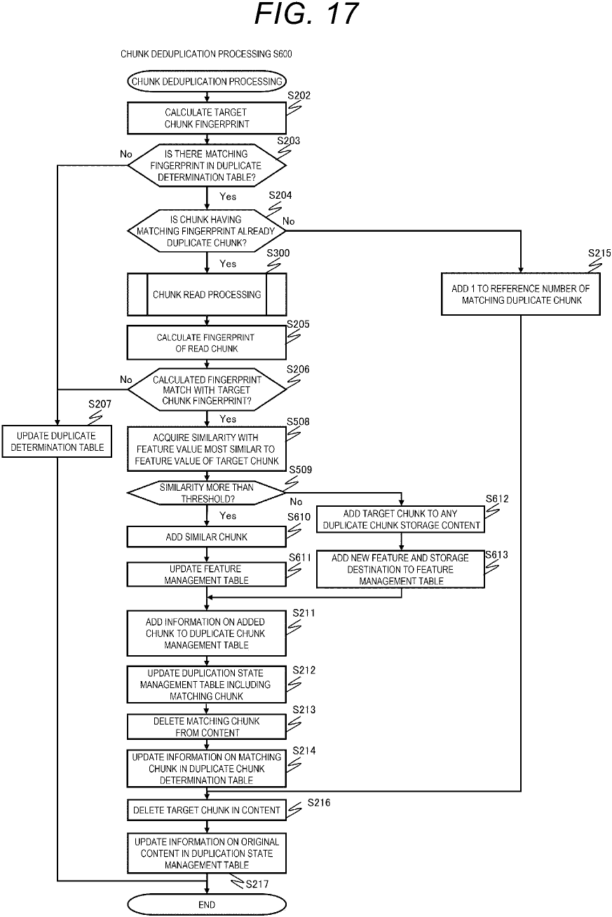

FIG. 16 is a configuration diagram of the feature management table according to the third embodiment.

The feature management table T71 is a table that is provided for each file system of the NAS 10 and manages the feature information for each duplicate chunk storage content in the file system, and stores an entry for each duplicate chunk stored in the duplicate chunk storage content. The entry of the feature management table T71 includes fields of a feature value C61, a content ID C62, an offset C63, a chunk length C64, and a similar chunk total length C65.

The feature value C61 stores a feature value of the duplicate chunk corresponding to the entry. The content ID C62 stores a content ID of the duplicate chunk storage content storing the duplicate chunk corresponding to the entry. The offset C63 stores a start position of the duplicate chunk corresponding to the entry in the duplicate chunk storage content. The chunk length C64 stores a data length (chunk length) of the duplicate chunk corresponding to the entry. The similar chunk total length C65 stores a total chunk length of the duplicate chunk corresponding to the entry and the duplicate chunk (similar chunk) having the similarity equal to or greater than the predetermined similarity.

Next, chunk deduplication processing according to the third embodiment will be described.

FIG. 17 is a flowchart of the chunk deduplication processing according to the third embodiment. In chunk deduplication processing S600 of FIG. 17, the same steps as those in the chunk deduplication processing S200 according to the first embodiment of FIG. 10 and the chunk deduplication processing S500 according to the second embodiment of FIG. 13 are denoted by the same reference numerals, and repeated description may be omitted.

Next, the content capacity reduction program 123 determines whether the acquired similarity is equal to or greater than a threshold (S509).

As a result, when the similarity is equal to or greater than the threshold (S509: Yes), the content capacity reduction program 123 adds the target chunk to the duplicate chunk storage content corresponding to the most similar feature value (S610), adds an entry corresponding to the target chunk, that is, an entry including a feature value of the target chunk, a content ID of the added duplicate chunk storage content, a start position and a chunk length of the target chunk, and a total value of the similar chunks to the feature management table T7 (S611), and causes the processing to proceed to step S211.

On the other hand, when the similarity is not equal to or greater than the threshold (S509: No), the content capacity reduction program 123 adds the target chunk to any duplicate chunk storage content (S612), adds an entry corresponding to the target chunk, that is, an entry including a feature value of the target chunk, a content ID of the added duplicate chunk storage content, a start position and a chunk length of the target chunk, and a total value of the similar chunks to the feature management table T7 (S613), and causes the processing to proceed to step S211.

Next, similar chunk content movement processing will be described.

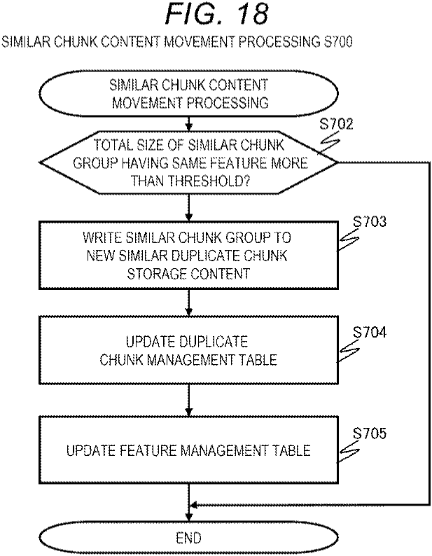

FIG. 18 is a flowchart of the similar chunk content movement processing according to the third embodiment.

Similar chunk content movement processing S700 may be executed, for example, in a background of another processing, or may be executed in the chunk deduplication processing S600.

The content capacity reduction program 123 refers to the feature management table T7, and determines whether a total size of groups of chunks (similar chunk groups) having the similarity of equal to or greater than the predetermined similarity (for example, similarity of 100%, that is, the same feature value) in the duplicate chunk storage content is equal to or greater than a threshold (S702).

As a result, when the total size of the similar chunk group in the duplicate chunk storage content is not equal to or greater than the threshold (S702: No), it means that it is not necessary to move the similar chunk group to a new duplicate chunk storage content. Therefore, the content capacity reduction program 123 ends the processing.

On the other hand, when the total size of the similar chunk group in the duplicate chunk storage content is equal to or greater than the threshold (S702: Yes), the content capacity reduction program 123 creates a new duplicate chunk storage content (similar duplicate chunk storage content) and writes the similar chunk group to the similar duplicate chunk storage content (S703).

Next, the content capacity reduction program 123 changes the content ID, the compressed data offset, and the compressed data length of the similar duplicate chunk storage content in the entry corresponding to the duplicate chunk storage content to be processed in the duplicate chunk management table T31 (S704), updates the content ID, the offset, the chunk length, and the similar chunk total length in the entry corresponding to the chunk of the similar chunk group in the feature management table T7 (S705), and ends the processing.

Next, a computer system according to a fourth embodiment will be described. The computer system according to the fourth embodiment is a system in which chunks that are not duplicate chunks (non-duplicate chunks) are also included in a duplicate chunk storage content, compressed, and managed in the computer system according to the fourth embodiment. In the computer system according to the fourth embodiment, parts similar to those of the computer system according to the first embodiment will be described using the same reference numerals.

FIG. 19 is a diagram showing a configuration for storing data according to the fourth embodiment.

FIG. 19 shows an example in which the content 310a, the content 310b, and the content 310c are included as the contents of the user stored in the NAS 10. Here, the content 310a includes the duplicate chunk 420a duplicating a chunk of another content, the duplicate chunk 420b, and the non-duplicate chunk 410a not duplicating a chunk of another content. The content 310b includes the duplicate chunk 420a, the duplicate chunk 420b, and a non-duplicate chunk 410b. The content 310c includes the duplicate chunk 420a and the duplicate chunk 420b.

In this case, when deduplication processing is performed, the duplicate chunks 420a are stored in the duplicate chunk storage content 320a and deleted from the contents 310a, 310b, and 310c, the duplicate chunks 420b are stored in the duplicate chunk storage content 320b and deleted from the contents 310a, 310b, and 310c, the non-duplicate chunk 410a is stored in the duplicate chunk storage content 320a in which the duplicate chunks 420a having high similarity to the non-duplicate chunk 410a are stored and deleted from the content 310a, and the non-duplicate chunk 410b is stored in the duplicate chunk storage content 320b in which the duplicate chunks 420b having high similarity to the non-duplicate chunk 410b are stored and deleted from the content 310b.

In this way, the non-duplicate chunk of each content is also stored in the duplicate chunk storage content in which the duplicate chunk similar to the non-duplicate chunk is stored. Accordingly, the compression efficiency can be improved.

Next, a duplication state management table T11 will be described.

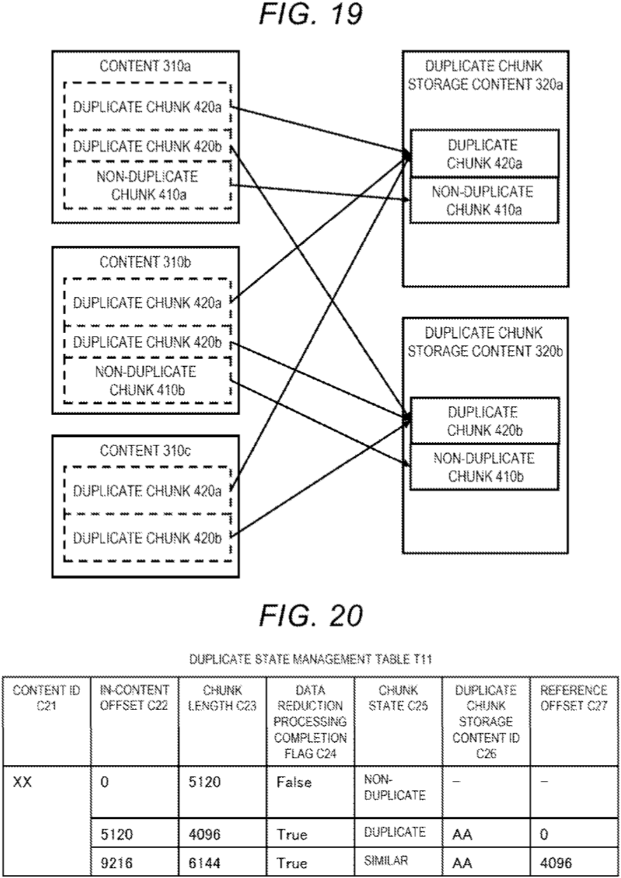

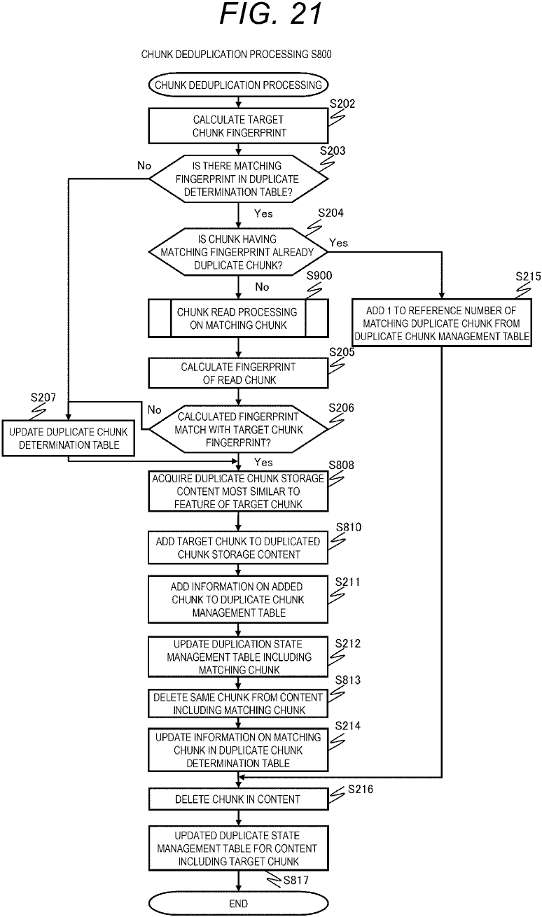

FIG. 20 is a configuration diagram of the duplication state management table according to the fourth embodiment.

The duplication state management table T11 includes an entry having the same configuration as that of the duplication state management table T1 shown in FIG. 5. In the duplication state management table T11, as a state of the chunk stored in the chunk state C25, “SIMILAR” indicating that the chunk is not a duplicate chunk but is similar to the duplicate chunk is newly set. When “SIMILAR” is set to the chunk state C25 corresponding to the entry, the duplicate chunk storage content ID C26 stores a content ID of the duplicate chunk storage content in which the chunk corresponding to the field group is stored, and the reference offset C27 stores an offset in the duplicate chunk storage content in which the data of the chunk corresponding to the field group is stored.

Next, chunk deduplication processing S800 according to the fourth embodiment will be described.

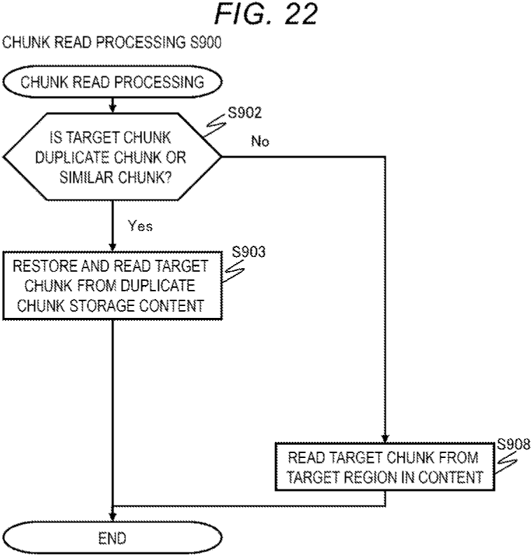

FIG. 21 is a flowchart of the chunk deduplication processing according to the fourth embodiment. In the chunk deduplication processing S800 of FIG. 21, the same steps as those in the chunk deduplication processings S200, S500, and S600 are denoted by the same reference numerals, and repeated description thereof may be omitted.

In step S204, when the matching chunk is not managed as the duplicate chunk (S204: No), the content capacity reduction program 123 executes chunk read processing (see FIG. 22) of reading the data of the chunk for the matching chunk (S900).

In step S206, when it is determined that the fingerprint of the matching chunk matches with the fingerprint of the target chunk (S206: Yes), or after step S207 is executed, the content capacity reduction program 123 specifies the duplicate chunk storage content that is most similar to (including the case of matching with) the feature of the target chunk (S808). Specifically, the content capacity reduction program 123 refers to the feature management table T7 based on a feature value of the target chunk, and specifies the content ID of the duplicate chunk storage content having the most similar feature value.

Next, the content capacity reduction program 123 adds the target chunk to the specified duplicate chunk storage content (S810), and causes the processing to proceed to step S211.

In steps S808 and S810, the duplicate chunk storage content storing the duplicate chunk most similar to the feature of the target chunk is acquired, and the target chunk is added to the duplicate chunk storage content. However, for example, when the similarity to the duplicate chunk storage content most similar to the target chunk is not equal to or greater than the threshold, the target chunk may be stored in the content as it is without being added to the duplicate chunk storage content.

Next, chunk read processing of step S900 will be described.

FIG. 22 is a flowchart of the chunk read processing according to the fourth embodiment.

The content capacity reduction program 123 determines whether a chunk to be processed (target chunk in the description of the processing) is a duplicate chunk or a similar chunk (S902). Specifically, the content capacity reduction program 123 refers to the entry of the target chunk in the duplication state management table T11, and determines whether the chunk state C25 is “DUPLICATE” or “SIMILAR”.

As a result, when the state is “DUPLICATE” or “SIMILAR” (S902: Yes), since the duplicate chunk storage content storing the target chunk is compressed and stored in the block storage 200, the content capacity reduction program 123 acquires the compressed target chunk from the block storage 200, restores the compressed target chunk (S903), and ends the processing.

On the other hand, when the state is not “DUPLICATE” or “SIMILAR” (S902: No), since the content storing the target chunk is not compressed, the content capacity reduction program 123 acquires the target chunk from the block storage 200 (S908) and ends the processing.

Next, chunk update processing will be described.

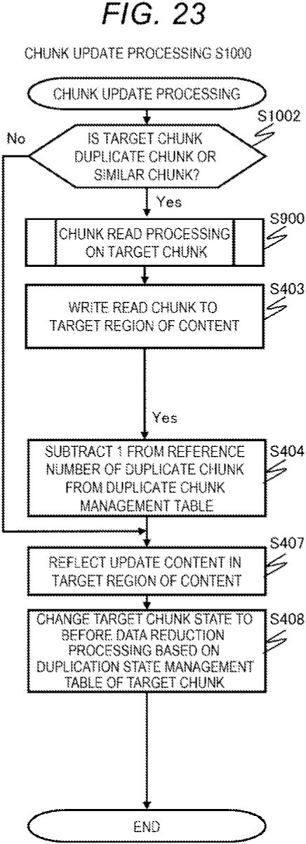

FIG. 23 is a flowchart of chunk update processing according to the fourth embodiment. In the chunk update processing of FIG. 23, the same steps as those in the chunk update processing S400 of FIG. 12 are denoted by the same reference numerals, and repeated description thereof may be omitted.

The chunk update processing is executed as an in-line process, for example, at the time of processing corresponding to a content update request from the client 11.

The content capacity reduction program 123 refers to the duplication state management table T1 and determines whether a chunk to be updated in the content (referred to as a target chunk in the processing) is a duplicate chunk or a similar chunk (S1002).

As a result, when the target chunk is not a duplicate chunk or a similar chunk (S1002: No), the content capacity reduction program 123 causes the processing to proceed to step S407.

On the other hand, when the target chunk is a duplicate chunk (S1002: Yes), the content capacity reduction program 123 performs the chunk read processing on the target chunk (S900).

Next, a computer system according to a fifth embodiment will be described. The computer system according to the fifth embodiment is different from the computer system according to the first embodiment in that the block storage 200 performs data compression and decompression processing.

The computer system according to the fifth embodiment will be described.

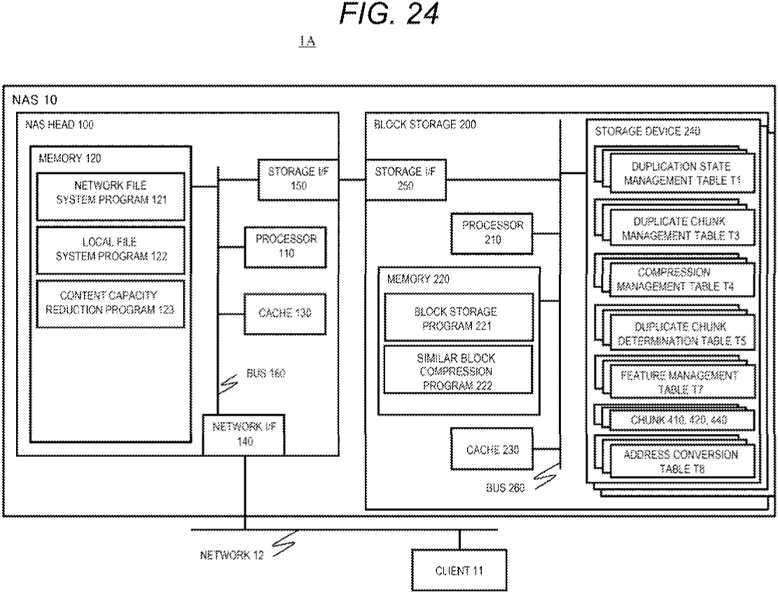

FIG. 24 is an overall configuration diagram of the computer system according to the fifth embodiment. In a computer system 1A, parts similar to those of the computer system 1 according to the first embodiment will be described using the same reference numerals.

A block storage 200A of the computer system 1A further stores a similar block compression program 222 in the memory 220 and further stores an address conversion table T8 in the storage device 240 with respect to the block storage 200 of the computer system 1 according to the first embodiment.

Next, the address conversion table T8 will be described.

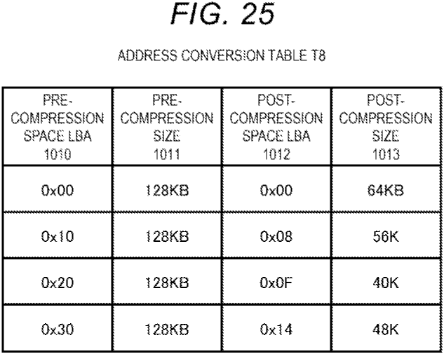

FIG. 25 is a configuration diagram of the address conversion table according to the fifth embodiment.

The address conversion table T8 stores a correspondence relationship between addresses of a pre-compression space and a post-compression space in the block storage 200. The address conversion table T8 stores an entry corresponding to each block in the pre-compression space. The entry of the address conversion table T8 includes a pre-compression space LBA 1010, a pre-compression size 1011, a post-compression space LBA 1012, and a post-compression size 1013.

The pre-compression space LBA 1010 stores a logical block address (LBA) in a pre-compression space of a block corresponding to the entry. The pre-compression size 1011 stores a size before compression of the block corresponding to the entry. The post-compression space LBA 1012 stores an LBA in a post-compression space of the block corresponding to the entry. The post-compression size 1013 stores a size after compression of the block corresponding to the entry.

Next, content data reduction processing S1100 in the NAS 10 will be described.

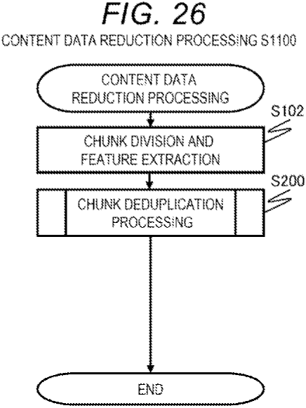

FIG. 26 is a flowchart of the content data reduction processing according to the fifth embodiment. In the content data reduction processing S1100 shown in FIG. 26, the same steps as those in the content data reduction processing S100 shown in FIG. 9 are denoted by the same reference numerals, and repeated description thereof may be omitted.

In the content data reduction processing S1100 in the computer system 1A, the steps S104 and S105 in the content data reduction processing S100 are not executed. That is, the NAS head 100 does not perform the data compression processing on the content.

In the computer system 1A, since restored data is transmitted from the block storage 200 in step S303 in the chunk read processing S300, the compressed data may not be restored.

Next, block data compression processing S1200 will be described.

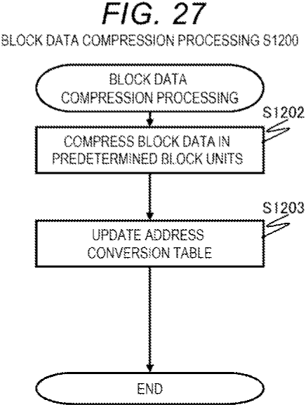

FIG. 27 is a flowchart of the block data compression processing according to the fifth embodiment. The block data compression processing is executed, for example, when the block storage 200 receives a write request of a block corresponding to a content from the NAS head 100.

The similar block compression program 222 (strictly speaking, the processor 210 that executes the similar block compression program 222) of the block storage 200 compresses data of a block to be written in units of a predetermined number of blocks, and stores the compressed data in the storage device 240 (S1202).

Next, the similar block compression program 222 updates the address conversion table T8 based on a result of the compression processing (S1203).

Here, when the similar block compression program 222 receives a read request for a compressed block from the NAS head 100, the similar block compression program 222 refers to the address conversion table T8, specifies a storage position of the instructed block, that is, an address of the post-compression space and the post-compression size, reads the block after compression from the storage device 240, restores (decompresses) the data of the block after compression, and returns the data to the NAS head 100.

According to the computer system 1A in the present embodiment, since the block storage 200 executes the compression and restoration processing of data, it is possible to reduce a load on the NAS head 100.

Next, a computer system according to a sixth embodiment will be described. In the computer system according to the sixth embodiment, for the sake of convenience, parts similar to those of the computer system according to the fifth embodiment shown in FIG. 24 will be described using the same reference numerals.

In the computer system according to the sixth embodiment, the NAS head 100 performs processing of detecting and managing similar chunks, notifies the block storage 200 of similar chunk specifying information capable of specifying the similar chunks, and the block storage 200 performs processing of collectively compressing blocks in which the similar chunks are stored based on the similar chunk specifying information.

The storage device 240 of the block storage 200 stores an address conversion table T81 instead of the address conversion table T8, and stores a feature management table T72 instead of the feature management table T7.

First, processing of grouping and compressing the similar chunks in the computer system 1A according to the sixth embodiment will be described.

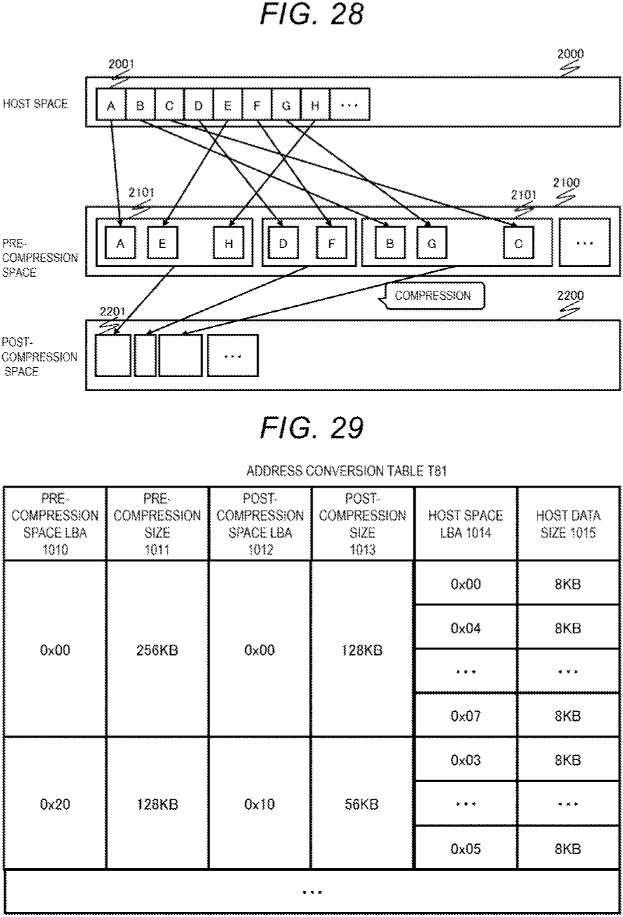

FIG. 28 is a diagram showing an outline of the processing of grouping and compressing the similar chunks according to the sixth embodiment.

The NAS head 100 detects similar chunks in a chunk 2001 of a content 2000, and notifies the block storage 200 of information capable of specifying the similar chunks (similar chunk specifying information). Here, chunks A, E, and H are similar chunks, chunks D and F are similar chunks, and chunks B, G, and C are similar chunks.

In the block storage 200, in response to a notification of the similar chunk specifying information, data of the similar chunks is arranged in a same group 2101 in a pre-compression space 2100. Specifically, the block storage 200 arranges the data of the chunks A, E, and H as one group, the data of the chunks D and F as one group, and the data of the chunks B, G, and C as one group in the pre-compression space 2100. Next, the block storage 200 compresses each group in the pre-compression space 2100 to obtain compressed data 2201, and arranges the compressed data in the post-compression space 2200. In this way, since the similar chunks are compressed as the same group, the compression efficiency can be improved.

FIG. 29 is a configuration diagram of an address conversion table according to the sixth embodiment. The same fields as those of the address conversion table T8 are denoted by the same reference numerals.

An entry of the address conversion table T81 includes fields of a set of one or more host space LBAs 1014 and a host data size 1015 in addition to the fields of the entry of the address conversion table T8.

The host space LBA 1014 stores a logical block address (LBA) in a host space of the chunk stored in the block corresponding to the entry. The host data size 1015 stores a data size in the host space of the chunk corresponding to the entry.

Next, the feature management table T72 will be described.

FIG. 30 is a configuration diagram of the feature management table according to the sixth embodiment.

The feature management table T72 is a table that manages the feature information for each chunk of the content of the file system, and stores an entry for each chunk. The entry of the feature management table T72 includes fields of a feature value C71, a host space address C72, and a block length C73.

The feature value C71 stores a feature value of the chunk corresponding to the entry. The host space address C72 stores an address of a start position in the host space of the chunk corresponding to the entry. The block length C73 stores a block length of the chunk corresponding to the entry.

Next, a special write command will be described. The special write command is a command for transmitting the similar chunk specifying information from the NAS head 100 to the block storage 200.

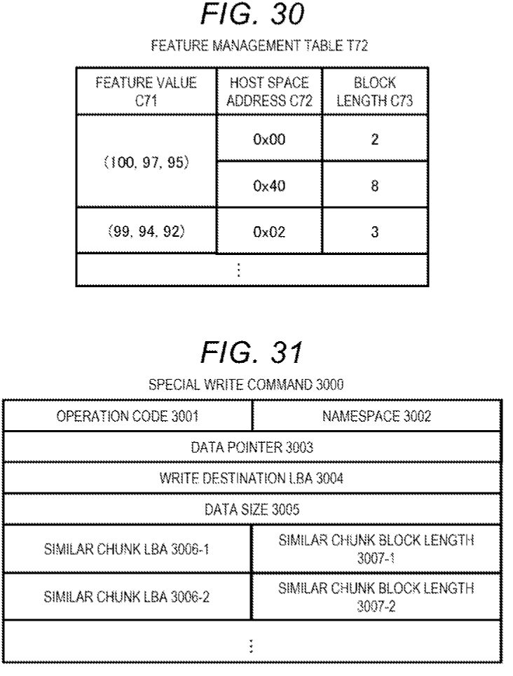

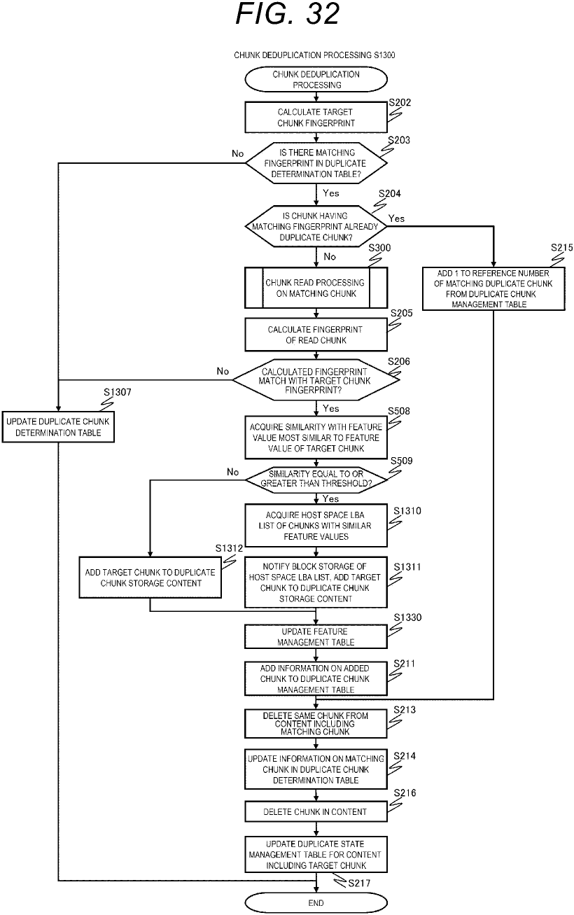

FIG. 31 is a configuration diagram of the special write command according to the sixth embodiment.

A special write command 3000 includes fields of an operation code 3001, a namespace 3002, a data pointer 3003, a write destination LBA 3004, a data size 3005, a plurality of similar chunk LBAs 3006 (3006-1, 3006-2, and the like), and a plurality of similar chunk block lengths 3007 (3007-1, 3007- 2, and the like).

The operation code 3001 stores a code indicating a special write command. The namespace 3002 stores a target namespace. The data pointer 3003 stores a pointer to data to be written. The write destination LBA 3004 stores a logical block address (LBA) indicating a block to which data is to be written in the pre-compression space in the block storage 200. The data size 3005 stores a data length of the data to be written. The similar chunk LBA 3006 (3006-1, 3006-2, and the like) stores an address of the similar chunk in the host space. The similar chunk block length 3007 (3007-1, 3007-2, and the like) stores a block length of each similar chunk. Here, the LBAs of the plurality of similar chunk LBAs 3006 of the special write command 3000 and the block lengths of the similar chunk block lengths 3007 are referred to as a similar chunk LBA list (an example of the similar chunk specifying information).

Next, chunk deduplication processing S1300 will be described.

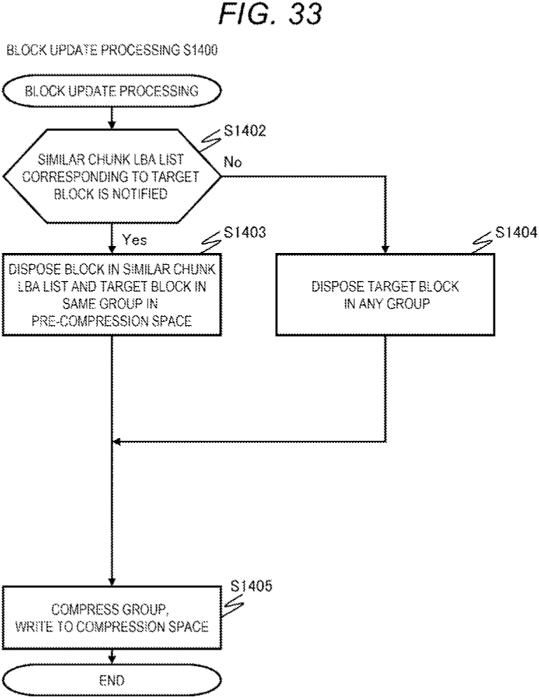

FIG. 32 is a flowchart of the chunk deduplication processing according to the sixth embodiment. In the chunk deduplication processing S1300 of FIG. 32, the same steps as those in the chunk deduplication processing (S200, S500, S600) in other embodiments are denoted by the same reference numerals, and repeated description thereof may be omitted.

In step S509, when the similarity is equal to or greater than the threshold (S509: Yes), the content capacity reduction program 123 acquires a list of host space LBAs (host space LBA list) of chunks having similar feature values (S1310), notifies the block storage 200 of a special write command including the host space LBA list, adds the target chunk to the duplicate chunk storage content (S1311), and causes the processing to proceed to step S1330.

On the other hand, when the similarity is not equal to or greater than the threshold (S509: No), the content capacity reduction program 123 stores the target chunk in any of the duplicate chunk storage contents (S511), and causes the processing to proceed to step S1330.

In step S1330, the content capacity reduction program 123 adds the information on the target chunk to the feature management table T72, and causes the processing to proceed to step S211.

Next, block update processing S1400 will be described.

FIG. 33 is a flowchart of the block update processing according to the sixth embodiment.

The block update processing S1400 is executed when a block update request is received from the content capacity reduction program 123.

First, the similar block compression program 222 (strictly speaking, the processor 210 that executes the similar block compression program 222) of the block storage 200 determines whether the similar chunk LBA list corresponding to a block (target block) that is a target of the block update request is notified of (S1402).

As a result, when the similar chunk LBA list is notified of (S1402: Yes), the similar block compression program 222 arranges the block storing the similar chunks stored in the similar chunk LBA list and the target block in the same group in the pre-compression space (S1403), and causes the processing to proceed to step S1405.

On the other hand, when the similar chunk LBA list is not notified of (S1402: No), the similar block compression program 222 disposes the target block in any group of the pre-compression space (S1404), and causes the processing to proceed to S1405.

In step S1405, the similar block compression program 222 performs compression processing for each group of the pre-compression space, writes the compressed data in the compression space, and then ends the block update processing.

In the computer system according to the present embodiment, the compression efficiency can be improved by the block storage 200 compressing a group of blocks including similar chunks.

The invention is not limited to the embodiments described above, and may be appropriately modified and implemented without departing from the gist of the invention.

For example, a part or all of the processing performed by the processor in the above embodiments may be performed by a hardware circuit. The programs in the embodiments described above may be installed from a program source. A program source may be a program distribution server or a recording medium (for example, a portable recording medium).

What is claimed is:

1. A storage system that, when data of a chunk included in a content matches with data of a chunk of another content, collects data of the chunks as a duplicate chunk storage content, performs compression processing on the duplicate chunk storage content, and stores the compressed duplicate chunk storage content in a storage device, wherein
a processor of the storage system specifies, when data of a chunk included in a predetermined content matches with data of a chunk of another content, a duplicate chunk storage content, in which a chunk similar to the chunks is stored, based on feature information on the chunks, and writes the chunks to the specified duplicate chunk storage content.

2. The storage system according to claim 1, wherein
the feature information on the chunks is information determined based on a plurality of hash values obtained by predetermined hash calculation for a plurality of partial data units of the chunks.

3. The storage system according to claim 2, wherein
the feature information is a set of a predetermined number of hash values from a larger hash value among the plurality of hash values, a set of a predetermined number of hash values from a smaller hash value among the plurality of hash values, and a set of hash values closest to an average value of the plurality of hash values or a plurality of predetermined values among the plurality of hash values.

4. The storage system according to claim 2, wherein
the processor
divides the contents into a plurality of chunks by applying a rolling hash, which calculates a hash value, to the contents while shifting a position of the partial data unit that calculates a hash, and
determines the feature information on the chunks based on the hash value obtained by the rolling hash.

5. The storage system according to claim 1, wherein
the processor creates, when the data of the chunk included in the predetermined content matches with the data of the chunk of the other content, an additional duplicate chunk storage content when there is no duplicate chunk storage content that stores a chunk similar to the chunks based on the feature information on the chunks, and writes the chunks to the created duplicate chunk storage content.

6. The storage system according to claim 1, wherein
the processor moves, when a similar chunk group having similar feature information stored in the duplicate chunk storage content satisfies a predetermined reference, the similar chunk group to an additional duplicate chunk storage content.

7. The storage system according to claim 6, wherein
the predetermined reference is a reference for a data length of the similar chunk group.

8. The storage system according to claim 1, wherein
the processor of the storage system specifies, for the chunk included in the predetermined content, the duplicate chunk storage content, in which the chunk similar to the chunk is stored, based on the feature information on the chunk, and writes the chunk to the specified duplicate chunk storage content.

9. The storage system according to claim 1, comprising:
a block storage including the storage device and configured to store data in the storage device in a block format; and
a content storage configured to manage the contents and cause the block storage to store the data of the contents in the block format, wherein
a processor of the content storage issues an instruction to compress the duplicate chunk storage content and store the compressed duplicate chunk storage content in the block storage in the block format.

10. The storage system according to claim 1, comprising:
a block storage including the storage device and configured to store data in the storage device in a block format; and
a content storage configured to manage the contents and cause the block storage to store the data of the contents in the block format, wherein
a processor of the content storage issues an instruction to store each content including the duplicate chunk storage content in the block storage in the block format, and
a processor of the block storage performs compression processing on a block instructed from the content storage in a predetermined unit and stores the block in the storage device.

11. The storage system according to claim 1, comprising:
a block storage including the storage device and configured to store data in the storage device in a block format; and
a content storage configured to manage the contents and cause the block storage to store the data of the contents in the block format, wherein
a processor of the content storage transmits, to the block storage, similar chunk specifying information configured to specify a block that stores a similar chunk storing data similar to the data of the chunk that matches with the data of the chunk of the another content, and
a processor of the block storage collectively compresses the chunk and data of the block that stores the similar chunk specified by the similar chunk specifying information, and writes the compressed chunk and data to the storage device.

12. A data management program executed by a computer constituting a storage system that, when data of a chunk included in a content matches with data of a chunk of another content, collects data of the chunks as a duplicate chunk storage content, performs compression processing on the duplicate chunk storage content, and stores the compressed duplicate chunk storage content in a storage device, wherein
the computer specifies, when data of a chunk included in a predetermined content matches with data of a chunk of another content, a duplicate chunk storage content, in which a chunk similar to the chunks is stored, based on feature information on the chunks, and writes the chunks to the specified duplicate chunk storage content.

13. A data management method performed by a storage system that, when data of a chunk included in a content matches with data of a chunk of another content, collects data of the chunks as a duplicate chunk storage content, performs compression processing on the duplicate chunk storage content, and stores the compressed duplicate chunk storage content in a storage device, the data management method comprising:
specifying, when data of a chunk included in a predetermined content matches with data of a chunk of another content, a duplicate chunk storage content, in which a chunk similar to the chunks is stored, based on feature information on the chunks; and
writing the chunks to the specified duplicate chunk storage content.
